(19) United States
(12) Patent Application Publication
(10) Pub. No.: US 2013/0033243 A1
(43) Pub. Date: Feb. 7, 2013

(54) DRIVE CIRCUIT OF POWER UNIT, AND POWER UNIT

(71) Applicant: Yoshihiro TAKEMAE, Minato (JP)

(72) Inventor: Yoshihiro TAKEMAE, Minato (JP)

(73) Assignee: FUJITSU SEMICONDUCTOR LIMITED, Yokohama-shi (JP)

(21) Appl. No.: 13/553,280

(22) Filed: Jul. 19, 2012

(30) Foreign Application Priority Data
Aug. 5, 2011 (JP) 2011-171486

(51) Int. Cl. G05F 1/10

(52) U.S. Cl. 323/271

(57) ABSTRACT

A drive circuit of a power unit, which includes a high-side transistor and a low-side transistor connected in series between a high potential power-supply line and a low potential power-supply line, and an inductor provided between a connection node of both of the transistors and an output terminal, and which drives both of the transistors, the drive circuit has: a first gate driver which drives a gate of the high-side transistor; and a second gate driver which drives a gate of the low-side transistor. In a transitional period of changing from a first state where the high-side transistor is ON and the low-side transistor is OFF to a second state where the high-side transistor is OFF and the low-side transistor is ON, the first gate driver drives the gate of the high-side transistor to a first voltage which is lower than a potential of the low potential power-supply line.

### CROSS-REFERENCE TO RELATED APPLICATION

This application is based upon and claims the benefit of priority of the prior Japanese Patent Application No. 2011-171486, filed on Aug. 5, 2011, the entire contents of which are incorporated herein by reference.

### FIELD

The present invention relates to a drive circuit of a power unit, and a power unit.

### BACKGROUND

A power unit lowers or raises the voltage of an input power source and thereby generates an output voltage of the intended potential. Here, a step down-type power unit includes a high-side transistor and a low-side transistor connected in series between a high potential power-supply line and a low potential power-supply line, and further includes an inductor provided between a connection node of both transistors and an output terminal, a control circuit for monitoring the output voltage of the output terminal and generating a control signal so that the output voltage becomes the intended potential, and a drive circuit for driving the gates of the high-side transistor and the low-side transistor according to the control signal.

The control circuit generates a control signal based on a predetermined modulation method such as PWM (pulse width modulation) or PFM (pulse frequency modulation). In addition, the drive circuit generates a first gate drive signal of the high-side transistor and a second gate drive signal of the low-side transistor according to the control signal. The drive circuit generates the first and second gate drive signals so as to alternately turn ON/OFF the high-side transistor and the low-side transistor, and so that both transistors will not be simultaneously turned ON during the transitional period.

The foregoing step down-type power unit is described, for example, in Japanese Patent Application Publication No. 2004-56982, Japanese Patent Application Publication No. 2008-113496, and Japanese Patent Application Publication No. 2002-44940.

### SUMMARY

When both the high-side transistor and the low-side transistor are N-channel transistors, the drive circuit causes a current to flow from the high potential power-supply line to the inductor and accumulated electromagnetic energy in the inductor in a first state where the high-side transistor is ON and the low-side transistor is OFF, and in the transitional period from the first state to a second state, it short-circuits between the gate and source of the high-side transistor and turns it OFF while maintaining the OFF state of the low-side transistor, and causes the potential of the connection node to drop due to the current generated by the electromagnetic energy accumulated in the inductor. In addition, after the potential of the connection node has sufficiently dropped in the transitional period, the low-side transistor is turned ON to achieve a second state where both transistors are OFF and ON. In the first state where the high-side transistor is ON, the potential of the connection node is kept high, and in the second state where the low-side transistor is ON, the potential of the connection node is lowered so as to inhibit the voltage between the drain and source of both transistors and thereby inhibit loss.

Nevertheless, when short-circuiting between the gate and source of the high-side transistor to turn it OFF while maintaining the OFF state of the low-side transistor in the foregoing transitional period, if the drive power of the transistor of the drive circuit is small, the potential of the gate of the high-side transistor is not lowered to the potential of the source. In particular, when the switching speed of the power unit is increased, the potential of the connection node of both transistors rapidly drops in the transitional period, and the potential of the gate of the high-side transistor is unable to follow the rapid drop of the connection node as the source, and there are cases where the connection node drops with the high-side transistor still in an ON state.

In the foregoing case, since the connection node is dropped, the voltage between the drain and source of the high-side transistor is high, and the loss of the high-side transistor will increase. With a power unit, since the inhibition of the loss of both transistors during the transitional period is an important factor for improving the efficiency of the overall power unit, the operation of the high-side transistor during the transitional period described above will lead to the increase of loss and deterioration of efficiency.

According to an embodiment, a drive circuit of a power unit which includes a high-side transistor and a low-side transistor connected in series between a high potential power-supply line and a low potential power-supply line, and an inductor provided between a connection node of both of the transistors and an output terminal, and which drives both of the transistors, the drive circuit has: a first gate driver which drives a gate of the high-side transistor; and a second gate driver which drives a gate of the low-side transistor. In a transitional period of changing from a first state where the high-side transistor is ON and the low-side transistor is OFF to a second state where the high-side transistor is OFF and the low-side transistor is ON, the first gate driver drives the gate of the high-side transistor to a first voltage which is lower than a potential of the low potential power-supply line.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a circuit diagram of the step down-type power unit.

FIG. 2 is a modified example of the power unit of FIG. 1.

FIG. 3 is a waveform diagram depicting the operation of the power unit of FIG. 2 during the transitional period from the first state to the second state.

FIG. 4 is a circuit diagram of the power unit in this embodiment.

FIG. 5 is a waveform diagram depicting the operation of the power unit of FIG. 4 in the transitional period from the first state to the second state.

FIG. 6 is a diagram depicting a circuit example of the first voltage generation circuit.

FIG. 7 is a schematic cross section of the high-side transistor Q1 and the low-side transistor Q2 which are used in the power unit of the second embodiment.

### DESCRIPTION OF EMBODIMENTS

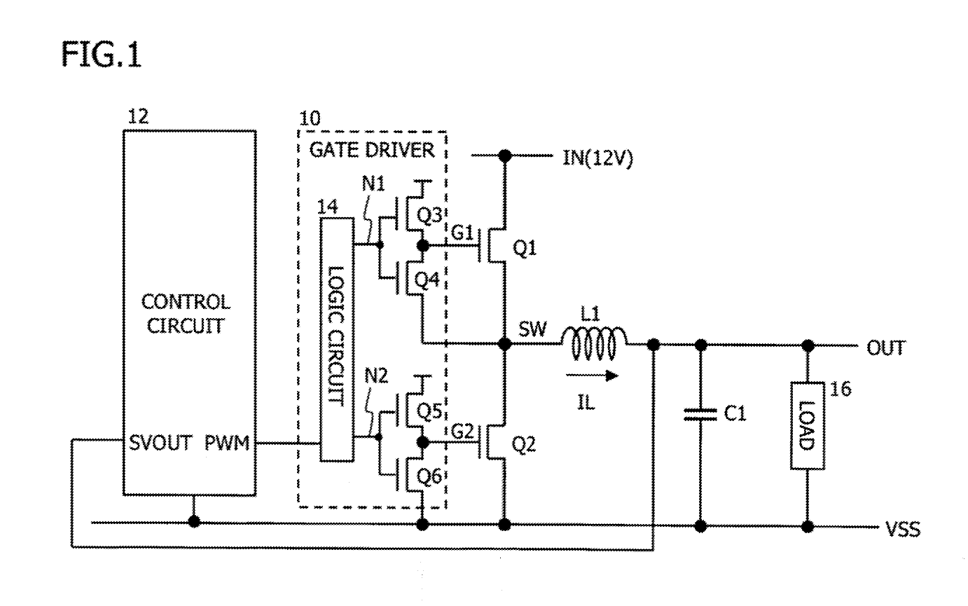

FIG. 1 is a circuit diagram of the step down-type power unit. This power unit includes a high-side transistor Q1 and a low-side transistor Q2 connected in series between a high potential power source IN to be input and a low potential power source VSS as the ground, an inductor L1 provided between a connection node SW of both transistors and an output terminal OUT, a smoothing condenser C1 provided to the output terminal OUT, a drive circuit 10 including a gate driver which drives the gates of both transistors Q1, Q2, and a control circuit 12 which monitors the potential of the output terminal OUT and generates a control signal PWM so that the potential of the output terminal OUT becomes the intended potential.

The high-side transistor Q1 and the low-side transistor Q2 are, for example, N-channel FETs, and preferably N-channel HEMTs (high electron mobility transistors), and the threshold voltage is equal. Moreover, the first gate drive which drives the gate of the high-side transistor Q1 in the drive circuit 10 is a complementary MOS inverter which includes a P-channel transistor Q3 and an N-channel transistor Q4. Similarly, the second gate driver which drives the gate of the low-side transistor Q2 is also a complementary MOS inverter including a P-channel transistor Q5 and an N-channel transistor Q6.

The drive circuit 10 drives the gates of both transistors Q1, Q2 according to the control signal PWM so that the first gate drivers Q3, Q4 and the second gate drivers Q5, Q6 alternately repeat a first state where the high-side transistor Q1 and the low-side transistor Q2 are ON/OFF, and a second state where the high-side transistor Q1 and the low-side transistor Q2 are OFF/ON. A logic circuit 14 in the drive circuit 10 generates control signals N1, N2 to the first and second gate drivers at respectively corresponding optimal potential levels, and generates the control signals so that both transistors Q1, Q2 will not simultaneously be in a conducting state in the transitional period between the first state and the second state.

When the control signal N1 becomes an L level and the control signal N2 becomes an H level, attained is a first state where the gate G1 becomes an H level and the high-side N-channel transistor Q1 is turned ON, and the gate G2 becomes an L level (VSS level) and the low-side N-channel transistor Q2 is turned OFF. Consequently, the potential of the connection node SW raised toward the high potential power source IN, an inductor current IL flows from the high potential power source IN to the inductor L1 through the high-side transistor Q1 in an ON state. Based on the generation of this inductor current IL, electromagnetic energy is accumulated in the inductor L1.

In the transitional period from the foregoing first state to the second state, the control signal N1 becomes an H level and the control signal N2 becomes an H level. Thus, the transistor Q4 is turned ON, the gate G1 becomes the same potential as the connection node SW, the high-side transistor Q1 is turned OFF, the transistor Q6 is turned ON, the gate G2 maintains the same potential of the low potential power source VSS, and the low-side transistor Q2 maintains its OFF state. When both transistors Q1, Q2 become an OFF state, the inductor current IL generated by the electromagnetic energy accumulated in the inductor L1 will flow continuously, and the potential of the connection node SW will drop from the high potential of the high potential power source IN toward the ground potential of the low potential power source VSS. However, since the gate G1 follows the potential drop of the connection node SW, the high-side transistor Q1 maintains its OFF state.

In addition, when the potential of the connection node SW drops from the ground VSS by a threshold voltage due to the inductor current IL, the low-side transistor Q2 is turned ON and the inductor current IL flows from the ground VSS via the low-side transistor Q2. In response to the drop in the connection node SW, the logic circuit 14 changes the control signal N2 to an L level, the gate G2 becomes an H level, and the low-side transistor Q2 becomes a completely ON state. The transition to the second state is thereby complete.

In the transitional period from the second state to the first state, the low-side transistor Q2 is foremost turned OFF to cause both transistors Q1, Q2 to enter an OFF state, the high-side transistor Q1 is thereafter turned ON, and the transitional operation to the first state is thereby complete. In the first state, based on the ON operation of the high-side transistor Q1, the current IL flows to the inductor L1 from the high potential power source IN via the transistor Q1. As a result, electromagnetic energy is accumulated in the inductor L1.

The control circuit 12 generates a control signal PWM so that the potential of the output terminal OUT is maintained at the intended potential. For example, the control circuit 12 performs control so as to extend the time for turning ON the high-side transistor Q1 when a load 16 connected to the output terminal OUT of the power unit is a heavy load, and shorten such time when it is a light load. Otherwise, in a separate example, the control circuit 12 performs control so as to maintain the ON time of the high-side transistor Q1 to be constant, increase the frequency of turning ON the high-side transistor Q1 when it is a heavy load, and lower such frequency when it is a light load.

In FIG. 1, the transistor Q4 is provided between the gate G1 and the source SW in the first gate drivers Q3, Q4 which drive the gate G1 of the high-side transistor Q1. Accordingly, in the transitional period from the first state to the second state, since the transistor Q4 is turned ON and the gate G1 and the connection node SW are of a short-circuited state, both transistors Q1, Q2 become an OFF/OFF state and, even if the connection node SW becomes lower than the ground VSS due to the inductor current IL, the OFF state of the high-side transistor Q1 is maintained. In addition, since the gate/source of the high-side transistor Q1 is short-circuited, it was possible to use a transistor with lower gate/source withstand voltage, such as a power MOS transistor, as the high-side transistor.

Nevertheless, pursuant to the speed-up of the switching control of both transistors Q1, Q2 due to demands for improving the accuracy of the output voltage, the potential of the connection node SW will drop rapidly in the transitional period from the first state to the second state. In the foregoing case, in cases where the size of the transistor Q4 is small and sufficient driving power is not available, the potential of the gate G1 is unable to follow the sudden drop of the potential of the connection node SW. Consequently, the gate/source of the high-side transistor Q1 becomes a threshold voltage or higher, and the potential of the connection node SW will drop but the high-side transistor Q1 is still in an ON state.

Here, since the voltage VDS between the drain and source of the high-side transistor Q1 has increased due to the drop of the connection node SW to the ground VSS, the high-side transistor Q1 enters an ON state, and loss of VDS×ID will arise (ID is a drain current). This induces considerable AC loss.

In a normal state, when the high-side transistor Q1 is in an ON state, the potential of the connection node SW is high. Meanwhile, when the low-side transistor Q2 is in a ON state, the potential of the connection node SW drops close to the ground VSS. Accordingly, the loss, or the DC loss, of both transistors in a normal state is not so great.

Accordingly, the increase of AC loss caused by the ON operation of the high-side transistor Q1 during the foregoing transitional period leads to the deterioration in the efficiency of the power unit, and is undesirable.

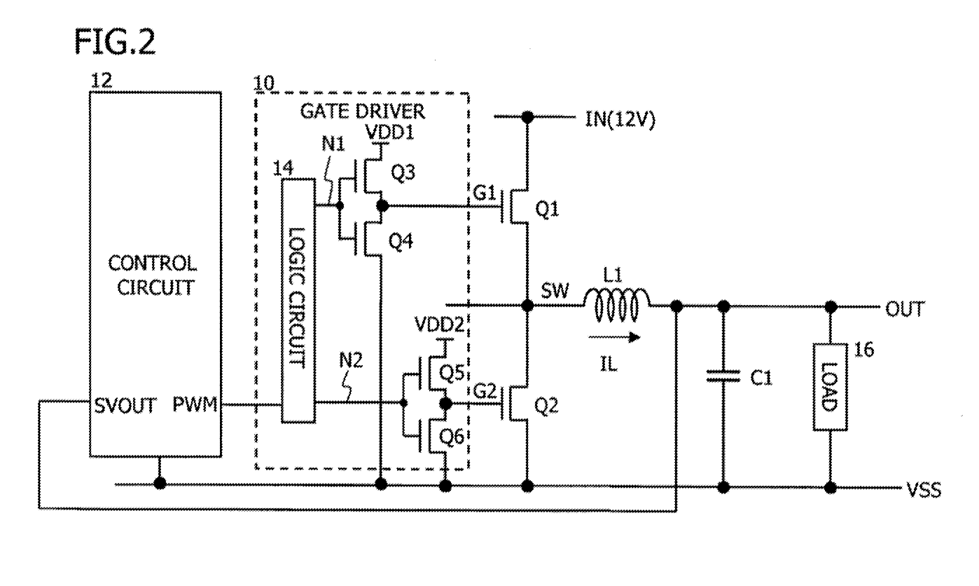

FIG. 2 is a modified example of the power unit of FIG. 1. With the power unit of FIG. 2, the source of the transistor Q4 of the first gate drivers Q3, Q4 in the drive circuit 10 is connected to the ground VSS as the low potential power source. The remaining configuration is the same as FIG. 1.

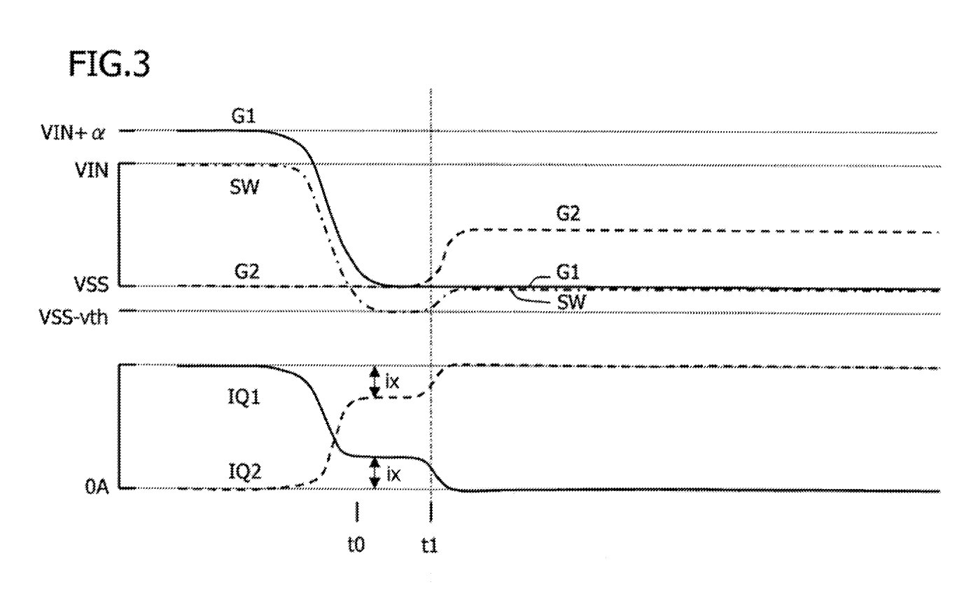

FIG. 3 is a waveform diagram depicting the operation of the power unit of FIG. 2 during the transitional period from the first state to the second state. The operation during the transitional period is now explained with reference to FIG. 3. In the transitional period from the first period where the high-side transistor Q1 is ON and the low-side transistor Q2 is OFF to the second state where the high-side transistor Q1 is OFF and the low-side transistor Q2 is ON, the logic circuit 14 changes the control signal N1 to an H level and turns ON the transistor Q4, discharges the charge of the gate G1 to the ground VSS, and the high-side transistor Q1 is turned OFF. On the low-side transistor Q2 side, the control signal N2 remains at an H level, and the gate G2 drops to the ground VSS and maintains the OFF state of Q2.

As with FIG. 1, with both transistors Q1, Q2 in an OFF state, the potential of the connection node SW drops drastically. Nevertheless, with the power unit of FIG. 2, since the source of the transistor Q4 of the first gate driver is connected to the ground VSS and the gate G1 of the high-side transistor Q1 is maintained at the ground VSS, the gate G1 is unable to follow during the drop of the connection node SW, and the high-side transistor Q1 does not turn ON.

However, since the inductor current IL is continuously flowing due to the electromagnetic energy accumulated in the inductor L1, the connection node SW drops from the high potential on the high potential power source IN side toward the ground VSS as the low potential power source. Even if the connection node SW becomes the potential of the ground VSS, the logic circuit 14 does not change the potential of the gate G2 to an H level during the time t0-t1 in order to prevent the through-current caused by both transistors Q1, Q2 being simultaneously turned ON. This time t0-t1 is the time that is required for driving the gate G2 to an H level after confirming that the gate G1 became the ground VSS and the connection node SW became negative potential.

In other words, since both gates G1, G2 of both transistors Q1, Q2 are the potential of the ground VSS, when the connection node SW further drops from the ground VSS by a threshold voltage of both transistors Q1, Q2 (time t0-t1), both transistors Q1, Q2 are turned ON, and the inductor current IL will flow from both the high-side transistor Q1 and the low-side transistor Q2.

In this state, since the connection node SW is a negative potential that is lower than the ground VSS, the voltage VDS between the drain and source of the high-side transistor Q1 will increase considerably, and cause considerable loss. Meanwhile, the voltage between the drain and source of the low-side transistor Q2 is not that great. The state where both transistors Q1, Q2 are turned ON continues until the control signal N2 is changed to an L level by the logic circuit 14, the gate G2 is changed to an H level, and the inductor current IL is supplied only from the low-side transistor Q2.

Accordingly, with the power unit of FIG. 2, the considerable loss caused by the ON operation of the high-side transistor Q1 at time t0-t1 in the transitional period shown in FIG. 3 will cause the deterioration in the efficiency of the power unit.

### First Embodiment

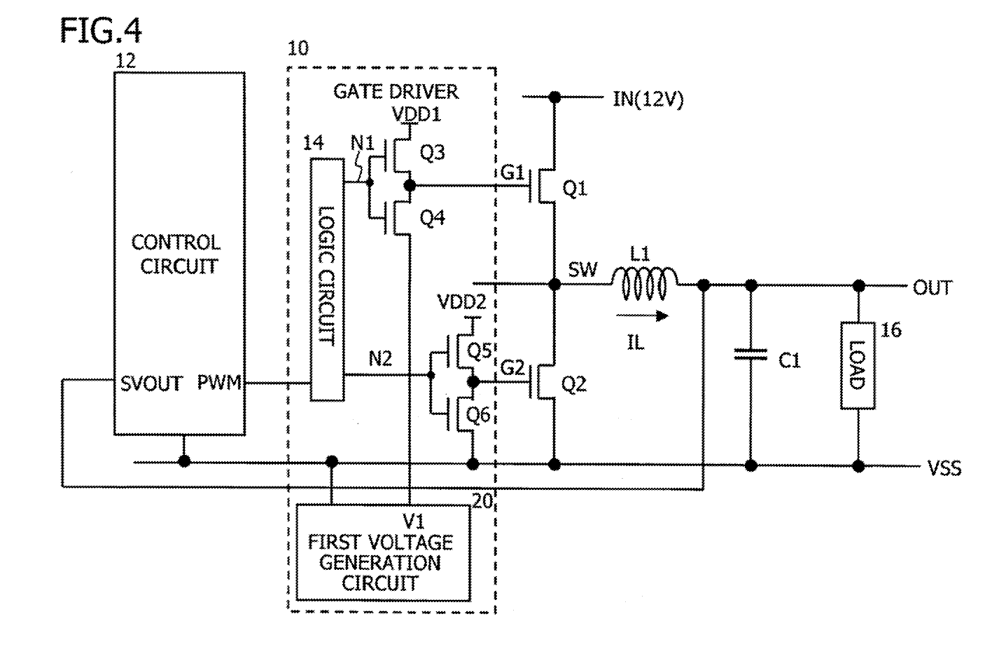

FIG. 4 is a circuit diagram of the power unit in this embodiment. The power unit of this embodiment includes, as with FIG. 1 and FIG. 3, a high-side transistor Q1 and a low-side transistor Q2 connected in series between a wiring line of a high potential power source IN and a wiring line of a low potential power source VSS, and an inductor L1 provided between a connection node SW of both transistors and an output terminal OUT. In addition, the power unit includes a drive circuit 10 including a gate driver which drives the gates of both transistors Q1, Q2, and a control circuit 12 which monitors the potential of the output terminal OUT and generates a control signal PWM so that the potential of the output terminal OUT becomes the intended potential.

Moreover, as with FIG. 1 and FIG. 3, high-side transistor Q1 and the low-side transistor Q2 are, for example, N-channel FETs, and preferably N-channel HEMTs (high electron mobility transistors), and the threshold voltage is equal.

Moreover, the first gate drive which drives the gate of the high-side transistor Q1 in the drive circuit 10 is a complementary MOS inverter which includes a P-channel transistor Q3 and an N-channel transistor Q4. Similarly, the second gate driver which drives the gate of the low-side transistor Q2 is also a complementary MOS inverter including a P-channel transistor Q5 and an N-channel transistor Q6. The source of the transistor Q3 of the first gate driver is connected to the first internal power source VDD1, and the source of the transistor Q5 of the second gate driver is connected to the second internal power source VDD2. In order turn ON the N-channel high-side transistor Q1, the first internal power source VDD1 is boosted higher than the input high potential power source IN by a threshold voltage of the transistor Q1 or higher. For example, the first internal power source VDD1 is connected to the connection node SW via a boost capacitor, and, when the high-side transistor Q1 is turned ON and the connection node SW rises, the first internal power source VDD1 is self-boosted based on the boost capacitor. The second internal power source VDD2 only needs to be a potential of a level capable of turning ON the low-side transistor Q2.

In addition, the drive circuit 10 of the power unit of FIG. 4 includes a first voltage generation circuit 20 which generates a first voltage V1 that is lower than the low potential power source VSS, and the first voltage V1 generated thereby is supplied to the source of the transistor Q4 of the first gate driver. This first voltage V1 is, for example, a negative potential that is lower than the ground VSS, and higher than VSS-Vth4 where the threshold voltage of the transistor Q4 is Vth4.

According to the foregoing configuration, in the transitional period from the first state to the second state, the transistor Q4 of the first gate drivers Q3, Q4 is turned ON due to the H level of the control signal N1, and the potential of the gate G1 of the high-side transistor Q1 is made to be a potential that is lower than the ground VSS of the low potential power source. Consequently, in the transitional period, since the gate G1 becomes a potential that is lower than the ground VSS of the low potential power source and the gate G2 becomes the ground VSS, both transistors Q1, Q2 are turned OFF, and, when the connection node SW becomes VSS-Vth(Q2) of the negative potential due to the inductor current IL, the low-side transistor Q2 is turned ON, but the voltage between the gate and source of the high-side transistor Q1 does not become a threshold voltage Vth(Q1) or higher, and is not turned ON.

The potential of the first voltage V1 is demanded to be a potential which turns ON only the low-side transistor Q2 and does not turn ON the high-side transistor Q1 when the connection node SW falls below the negative potential, and a potential which does not turn ON the transistor Q4. In other words, the potential of the first voltage V1 is in the range of (VSS-α) to (VSS-Vth(Q4)). Here, a corresponds to the overdrive voltage for substantially turning ON the low-side transistor Q2. If the gate G2 is the potential of the ground VSS and the gate G1 is a potential of VSS-α, Q1 maintains its OFF state even when Q2 is turned ON and the node SW becomes Vss-Vth(Q2).

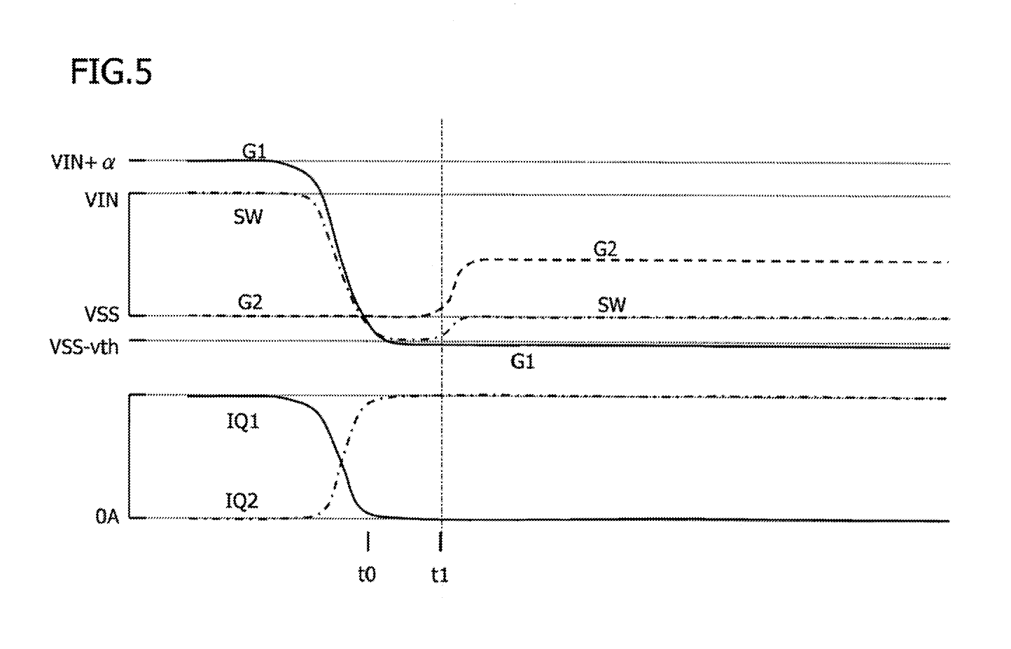

FIG. 5 is a waveform diagram depicting the operation of the power unit of FIG. 4 in the transitional period from the first state to the second state. The operation in the transitional period is now explained with reference to FIG. 5. In the transitional period from the first period where the high-side transistor Q1 is ON and the low-side transistor Q2 is OFF to the second state where the high-side transistor Q1 is OFF and the low-side transistor Q2 is ON, the logic circuit 14 changes the control signal N1 to an H level and turns ON the transistor Q4, discharges the charge of the gate G1 to the first voltage V1 that is lower than the ground VSS, and the high-side transistor Q1 is turned OFF. On the low-side transistor Q2 side, the control signal N2 remains at an H level, and the gate G2 drops to the ground VSS and maintains the OFF state.

Since both transistors Q1, Q2 are in an OFF state, the potential of the connection node SW drops drastically due to the inductor current IL heading from the connection node SW to the output terminal OUT. At time t0, when the connection node SW becomes VSS-Vth(Q2) which is lower than the ground VSS, the low-side transistor Q2 is turned ON since the voltage between the gate G2 and the connection node SW become a threshold Vth(Q2) or higher. Nevertheless, since the gate G1 of the high-side transistor Q1 is driven to the potential V1 that is lower than the ground VSS, the voltage between the gate and source of Q1 will not become the threshold voltage Vth(Q1) or higher, and the high-side transistor Q1 will not be turned ON. Accordingly, it is possible to prevent the generation of considerably loss due to the high-side transistor Q1 being turned ON.

At time t1, the logic circuit 14 changes the control signal N2 to an L level and the second gate drivers Q5, Q6 change the gate G2 to an H level. Consequently, even if the potential of the connection node SW returns to the ground VSS from the negative potential due to the drop of the inductor current IL, the ON state of the low-side transistor Q2 is maintained. The transition to the second state is thereby complete.

As described above, particularly at time t0-t1 in the transitional period, since the gate G1 of the high-side transistor Q1 is controlled to the first voltage V1 that is lower than the ground VSS, which is the low potential power source, even if the connection node SW becomes VSS-Vth(Q2) that is lower than the ground VSS, the high-side transistor Q1 is not turned ON, and loss caused by Q1 being turned ON will not arise.

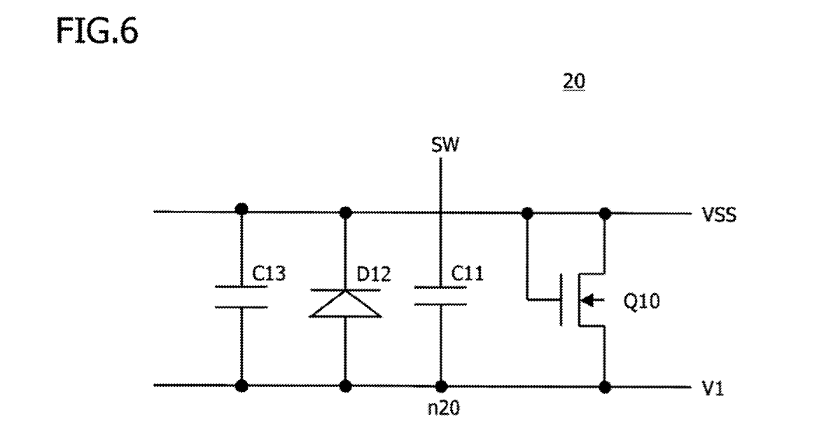

FIG. 6 is a diagram depicting a circuit example of the first voltage generation circuit 20. The first voltage generation circuit 20 is a bootstrap circuit, and includes a boost capacitor C11, a stabilization capacitor C13, a clamp transistor Q10, and a clamp diode D12. In addition, one electrode of the boost capacitor C11 is connected to the connection node SW, and the other electrode is connected to a node n20 to which the first voltage V1 is generated.

In this power unit, when the high-side transistor Q1 and the low-side transistor Q2 alternately repeat the first state (ON, OFF) and the second state (OFF, ON), the connection node SW alternately changes between the potential of the high potential power source IN and the potential of the ground VSS as the low potential power source. By using the signals that change above and below at the connection node SW, the first voltage generation circuit changes the node n20 to one of the negative potentials between (VSS-α) to (VSS-Vth(Q4)) based on the boost capacitor C11.

When the connection node SW is changed to an H level, the node n20 will rise due to the coupling of the capacitor C11, but is clamped by the clamp diode D12 to the potential of the forward voltage VF from the ground VSS. In addition, when the connection node SW changes from an H level to an L level, the node n20 drops due to the coupling of the capacitor C11, and the negative charge associated therewith is charged in the capacitor C13. As a result of repeating the foregoing operation, the node n20 steps down to a negative potential that is lower than the ground VSS. However, due to the clamp transistor Q10, the node n20 will not become lower than the potential VSS-Vth(Q10), which is lower than the ground VSS by the threshold voltage Vth. If Vth(Q10)=Vth(Q4) is set, the first voltage V1 will be maintained at one of the negative potentials between (VSS-α) to (VSS-Vth(Q4)).

In the embodiment of FIG. 4, since the gate G2 of the low-side transistor Q2 is driven to the ground VSS in the transitional period, the gate G1 is set to the potential V1 that is lower than the ground VSS and higher than VSS-Vth4 that will not turn ON the transistor Q4 so that the high-side transistor Q1 will not be turned ON when the connection node SW drops to the negative potential.

When the gate G2 of the low-side transistor Q2 is driven to a potential other than the ground VSS; for instance, VSS-α or VSS+α, the gate G1 of the high-side transistor Q1 should be driven to a potential that is higher than the gate G2. In other words, in a state where both of the N-channel transistors Q1, Q2 are using the connection node SW of the negative potential as the common source, if the potential of the gate G1 is higher than the potential of the gate G2, the high-side transistor Q1 will not be turned ON even if the low-side transistor Q2 is turned ON.

### Modified Example of First Embodiment

With the first embodiment shown in FIGS. 4 and 5, especially at time t0-t1 of the transitional period from the first state to the second state, the first gate drivers Q3, Q4 drove the gate G1 of the high-side transistor Q1 to a negative voltage that is lower than the ground VSS as the low potential power source. Nevertheless, in the second state after time t1, even if the gate G1 is maintained at the ground VSS, the OFF state of the high-side transistor Q1 is not affected since the gate G2 is of an H level that is higher than the ground VSS.

Thus, in this modified example, the first voltage generation circuit 20 performs a step-down operation using the pulse signals of the connection node SW at least during the period of time t0-t1 of the transitional period, discontinues the input of the signals of the connection node SW after time t1, and stops the step-down operation. Consequently, the node n20 in FIG. 6 rises to the ground VSS, the first voltage V1 becomes the potential of the ground VSS, and the gate G1 of the high-side transistor Q1 also becomes the potential of the ground VSS.

### Second Embodiment

The circuit diagram of the power unit of the second embodiment is the same as FIG. 2. However, the high-side transistor Q1 and the low-side transistor Q2 are both N-channel HEMTs, and the threshold voltage of the high-side transistor Q1 is formed to be higher than the threshold voltage of the low-side transistor Q2.

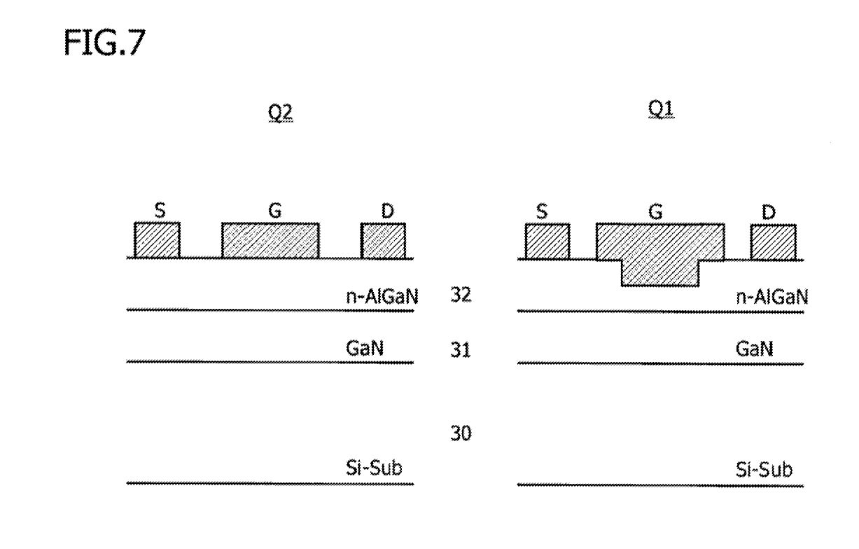

FIG. 7 is a schematic cross section of the high-side transistor Q1 and the low-side transistor Q2 which are used in the power unit of the second embodiment. With both the high-side transistor Q1 and the low-side transistor Q2, a non-doped GaN channel layer 31, an N-type AlGaN electron supply layer 32, a gate electrode G, a source electrode S, and a drain electrode D are formed on a Si substrate 20, and electrons of the electron supply layer 32 form a two-dimensional electron gas layer at the interface with the channel layer 31. Note that the Si substrate 20 may be substituted with a SiC substrate. In addition, the configuration is such that the distance from the gate electrode G of the high-side transistor Q1 to the channel layer 31 is shorter than the low-side transistor Q2. Consequently, the threshold voltage of the high-side transistor Q1 becomes higher than the low-side transistor Q2.

With the configuration of FIG. 2, as shown in FIG. 3, at time t0-t1 in the transitional period from the first state to the second state, both gates G1, G2 of the high-side transistor Q1 and the low-side transistor Q2 are driven to the potential of the ground VSS. Nevertheless, since the threshold voltage of Q1 is greater than that of Q2, even if the connection node SW drops to VSS-Vth due to the inductor current IL, only the low-side transistor Q2 is turned ON, and the high-side transistor Q1 will not be turned ON.

The high-side transistor Q1 and the low-side transistor Q2 in the first embodiment of FIG. 4 are both N-channel HEMTs configured as shown in FIG. 7. However, the structure of the gate electrodes of both transistors is the same, and the threshold voltage is also the same.

In the power unit of the first and second embodiments, the high-side transistor Q1 and the low-side transistor Q2 have the structure shown in FIG. 7, and are formed on the same Si substrate.

As described above, according to the power unit of this embodiment, it is possible to inhibit the deterioration of loss since it is possible to prevent the high-side transistor from conducting according to a state where the voltage between the drain and source is high in the transitional period during the switching operation of the high-side transistor and the low-side transistor.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. A drive circuit of a power source apparatus which includes a first transistor and a second transistor connected in series between a first power-supply line and a second power-supply line of which potential is lower than a potential of the first power-supply line, and an inductor provided between a connection node of both of the transistors and an output terminal, and which drives both of the transistors,
the drive circuit comprising:
a first gate driver which drives a gate of the first transistor; and
a second gate driver which drives a gate of the second transistor,
wherein, in a transitional period of changing from a first state where the first transistor is ON and the second transistor is OFF to a second state where the first transistor is OFF and the second transistor is ON, the first gate driver drives the gate of the first transistor to a first voltage which is lower than a potential of the second power-supply line.

2. The drive circuit of a power source apparatus according to claim 1, wherein, in the transitional period, the second gate driver drives the gate of the second transistor to a potential of the second power-supply line.

3. The drive circuit of a power source apparatus according to claim 1, further comprising:
a first voltage generation circuit which is connected to the second power-supply line and the connection node, and which generates the first voltage by a repeat of raising and lowering a potential of the connection node.

4. The drive circuit of a power source apparatus according to claim 3, wherein
the first gate driver includes a first driver transistor provided between the gate of the first transistor and an output of the first voltage generation circuit, and
a potential of the first voltage is higher than a potential that is lower than the potential of the second power-supply line by a threshold voltage of the first driver transistor.

5. A drive circuit of a power source apparatus which includes a first transistor and a second transistor connected in series between a first power-supply line and a second power-supply line of which potential is lower than a potential of the first power-supply line, and an inductor provided between a connection node of both of the transistors and an output terminal, and which drives both of the transistors,
the drive circuit comprising:
a first gate driver which drives a gate of the first transistor; and
a second gate driver which drives a gate of the second transistor,
wherein, in a transitional period of changing from a first state where the first transistor is ON and the second transistor is OFF to a second state where the first transistor is OFF and the second transistor is ON, the first gate driver drives the gate of the first transistor to a first voltage, and the second gate drive drives the gate of the second transistor to a second voltage that is higher than the first voltage.

6. A power source apparatus, comprising:
a first transistor and a second transistor connected in series between a first power-supply line and a second power-supply line of which potential is lower than a potential of the first power-supply line;
an inductor provided between a connection node of both of the transistors and an output terminal; and
a drive circuit which drives the gates of both of the transistors so as to alternately turn ON and OFF the first transistor and the second transistor, wherein
the drive circuit includes:
a first gate driver which drives a gate of the first transistor; and
a second gate driver which drives a gate of the second transistor, and wherein
in a transitional period of changing from a first state where the first transistor is ON and the second transistor is OFF to a second state where the first transistor is OFF and the second transistor is ON, the first gate driver drives the gate of the first transistor to a first voltage which is lower than a potential of the second power-supply line.

7. The power source apparatus according to claim 6, wherein, in the transitional period, the second gate driver drives the gate of the seconds transistor to a potential of the second power-supply line.

8. The power unit according to claim 6, further comprising:
a first voltage generation circuit which is connected to the second power-supply line and the connection node, and which generates the first voltage by a repeat of raising and lowering a potential of the connection node.

9. The power source apparatus according to claim 8, wherein
the first gate driver includes a first driver transistor provided between the gate of the first transistor and an output of the first voltage generation circuit, and
a potential of the first voltage is higher than a potential that is lower than the potential of the second power-supply line by a threshold voltage of the first driver transistor.

10. A power source apparatus, comprising:
a first transistor and a second transistor connected in series between a first power-supply line and a second power-supply line of which potential is lower than a potential of the first power-supply line;
an inductor provided between a connection node of both of the transistors and an output terminal; and
a drive circuit which drives the gates of both of the transistors so as to alternately turn ON and OFF the first transistor and the second transistor, wherein
the drive circuit includes:
a first gate driver which drives a gate of the first transistor; and
a second gate driver which drives a gate of the second transistor, and wherein
in a transitional period of changing from a first state where the first transistor is ON and the second transistor is OFF to a second state where the first transistor is OFF and the second transistor is ON, the first gate driver drives the gate of the first transistor to a first voltage, and the second gate drive drives the gate of the second transistor to a second voltage that is higher than the first voltage.

11. A power source apparatus, comprising:
a first transistor and a second transistor connected in series between a first power-supply line and a second power-supply line of which potential is lower than a potential of the first power-supply line;
an inductor provided between a connection node of both of the transistors and an output terminal; and
a drive circuit which drives the gates of both of the transistors so as to alternately turn ON and OFF the first transistor and the second transistor, wherein
a threshold voltage of the first transistor is larger than a threshold voltage of the second transistor, and
in a transitional period of changing from a first state where the first transistor is ON and the second transistor is OFF to a second state where the first transistor is OFF and the second transistor is ON, the first and second gate drivers drive the gates of the first transistor and the second transistor to a same voltage.

12. The power source apparatus according to claim 11, wherein the first transistor and the second transistor are high electron mobility transistors (HEMT).
